(19) United States
(12) Patent Application Publication
(10) Pub. No.: US 2016/0362880 A1
(43) Pub. Date: Dec. 15, 2016

(54) Kitchen slurry transportation device

(71) Applicant: Bioland Environmental Technologies Group Corp. Ltd. (Beijing Branch), Beijing (CN)

(72) Inventors: Yichao Ping, Beijing (CN); Chao Wang, Beijing (CN); Rulin Qiao, Beijing (CN)

(73) Assignee: Bioland Environmental Technologies Group Corp. Ltd. (Beijing Branch)

(21) Appl. No.: 15/212,247

(22) Filed: Jul. 17, 2016

(30) Foreign Application Priority Data
Jul. 17, 2015 (CN) 201520524777.8

(51) Int. Cl. E03C 1/266; B02C 18/00

(52) U.S. Cl. CPC E03C 1/2665; B02C 18/0092

(57) ABSTRACT

A kitchen slurry transportation device includes a power mechanism, a transmission device, a pump body, a cutting blade, and a discharging pipeline. A feeding inlet is arranged at a bottom part of the pump body. A discharging port is arranged on a sidewall of the pump body. The discharging port is intercommunicated with the pipeline. An impeller is arranged in the pump body and sleeved on a first section of the transmission device. The cutting blade is sleeved on a second section of the transmission device. The impeller is arranged in a cavity of the pump body. The cutting blade is arranged outside the pump body. The impeller and the blade are arranged coaxially, constituting a double crushing system, which is able to effectively crush and stir kitchen waste and beneficial for transporting waste slurry. The present invention has advantages of easy cleaning and maintenance, low cost, and simple structure.

### CROSS REFERENCE OF RELATED APPLICATION

The application claims priority under 35 U.S.C. 119(a-d) to CN 201520524777.8, filed Jul. 17, 2015.

### BACKGROUND OF THE PRESENT INVENTION

Field of Invention

The present invention relates to a technical field of kitchen waste treatment in environmental protection industry, and more particularly to a kitchen slurry transportation device.

Description of Related Arts

Since 1980s, Chinese society, economy, and culture have deeply changed. The economy develops rapidly, the living standard of people is greatly improved, and the municipal solid waste increases exponentially. In 1987, the transportation amount of the municipal domestic waste is 53.98 million tons; in 1997, the transportation amount increases to 120 million tons; and, in 2008, the transportation amount reaches 155 million tons, namely the per-capita daily domestic waste output is 1-1.2 kg.

Therefore, it is required to transport the great amount of the solid waste. In existing technology, because of the complexity of the waste, the conventional pumps, such as the slurry pump, the mud pump, and the screw pump, are all unsuited for transporting the solid waste slurry. Thus, it is important to provide a specialized transportation device for transporting the solid waste slurry.

### SUMMARY OF THE PRESENT INVENTION

An object of the present invention is to provide a kitchen slurry transportation device, which is able to effectively solve above problems.

Technical solutions of the present invention are described as follows.

A kitchen slurry transportation device comprises a power mechanism, a transmission device, a pump body, a cutting blade, and a discharging pipeline, wherein:

a top end of the transmission device is linked with an output end of the power mechanism; a bottom end of the transmission device penetrates through a cavity of the pump body and is located below the pump body; a section of the transmission device, which is located in the cavity of the pump body, is denoted as a first section of the transmission device; and, a section of the transmission device, which is located outside the cavity of the pump body and below the pump body, is denoted as a second section of the transmission device;

a feeding inlet is arranged at a bottom part of the pump body; a discharging port is arranged on a sidewall of the pump body; the discharging port is intercommunicated with the discharging pipeline; an impeller is arranged in the pump body; and, the impeller is fixedly sleeved on the first section of the transmission device; and

the cutting blade is fixedly sleeved on the second section of the transmission device.

Preferably, the power mechanism is an electric motor or a hydraulic motor.

Preferably, the transmission device is a rotation shaft.

Preferably, a distance between the cutting blade and the impeller is 170 mm.

Preferably, the cutting blade is double-blade-typed and edged, the cutting blade is arranged horizontally, and an edge angle thereof is 60°; the impeller has four vanes, and an edge of each vane is a cutting edge.

Preferably, the transportation device further comprises an eccentric barrier, which is fixedly sleeved on the transmission device; and the eccentric barrier is located between the cutting blade and the impeller.

Preferably, the transportation device further comprises a stainless steel pipeline.

A section of the transmission device, which is located above the pump body, is denoted as a third section of the transmission device.

The stainless steel pipeline is hermetically sleeved outside the third section of the transmission device.

Preferably, a flange and/or an expanding supporter are fixedly arranged outside the stainless steel pipeline.

Preferably, a mechanical sealing element is arranged at a top part of the pump body, for avoiding a slurry leakage.

The kitchen slurry transportation device provided by the present invention has following advantages.

The impeller is arranged in the cavity of the pump body. The cutting blade is arranged outside the pump body. The impeller and the cutting blade are arranged coaxially, constituting a double crushing system, which is able to effectively crush and stir the kitchen waste and beneficial for the waste slurry transportation. Moreover, the present invention has advantages of easy cleaning and maintenance, low cost, and simple structure.

These and other objectives, features, and advantages of the present invention will become apparent from the following detailed description, the accompanying drawings, and the appended claims.

### BRIEF DESCRIPTION OF THE DRAWINGS

FIG. 1 is a front view of a kitchen slurry transportation device according to a preferred embodiment of the present invention.

FIG. 2 is a sectional view of the kitchen slurry transportation device according to the preferred embodiment of the present invention.

### DETAILED DESCRIPTION OF THE PREFERRED EMBODIMENT

The present invention is further illustrated with accompanying drawings in detail.

Because kitchen waste slurry has a water content of about 90% and a complex composition including plastic, bones, and even metals and stones, the kitchen waste slurry has greatly high requirements on a pump. Thus, it is difficult to transport the kitchen waste slurry with a conventional pump.

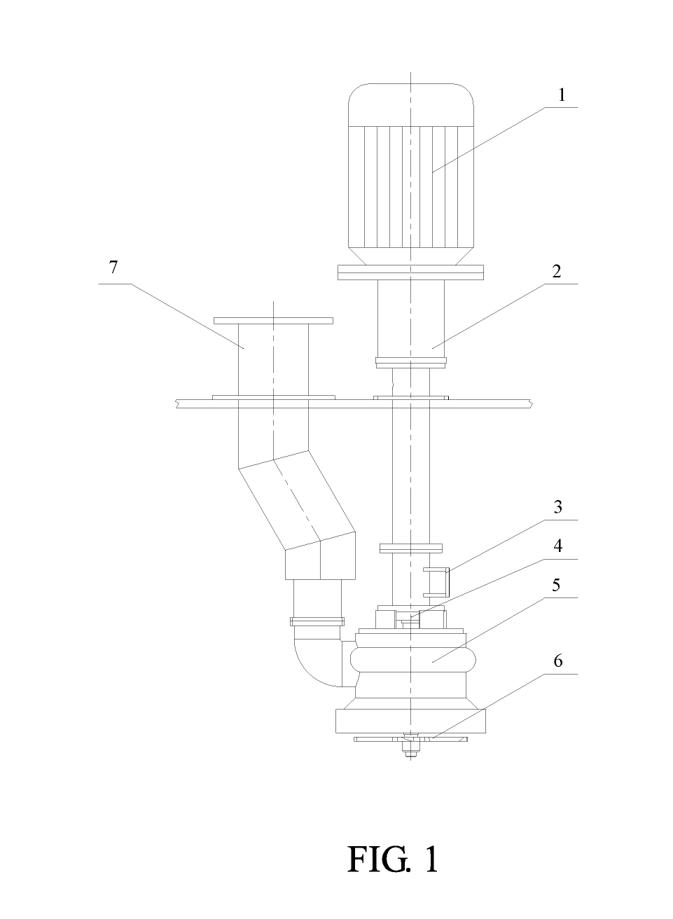

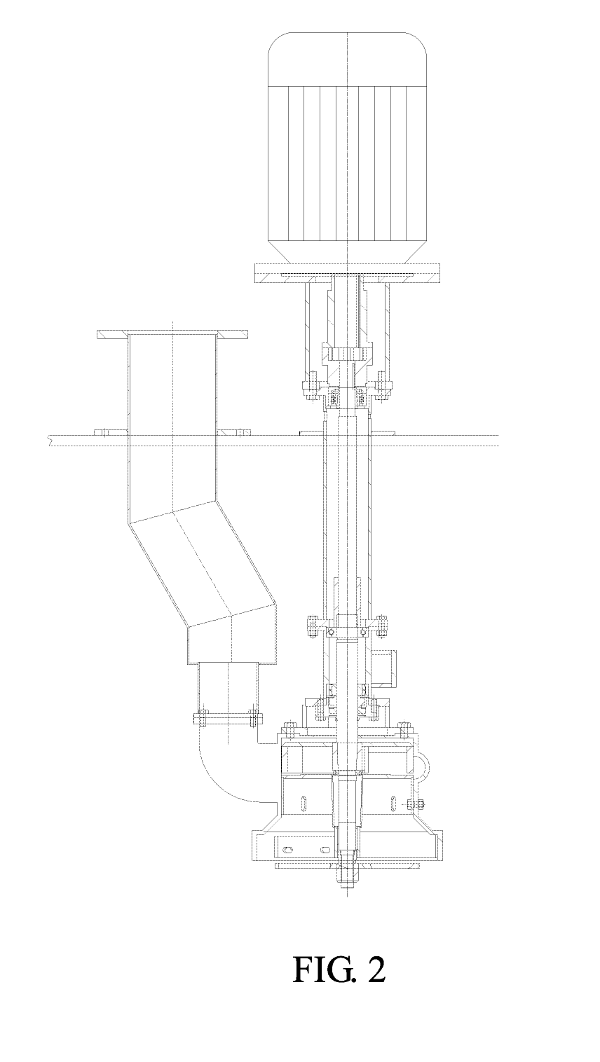

For above problems, according to a preferred embodiment of the present invention, a kitchen slurry transportation device as showed in FIG. 1 and FIG. 2 is provided, which is a specialized device for transporting the kitchen waste slurry, comprising a power mechanism 1, a transmission device 2, a pump body 5, a cutting blade 6, and a discharging pipeline 7; wherein: according to actual working conditions, various power mechanisms are flexibly selected, such as an electric motor or a hydraulic motor.

In a practical application, it is feasible to adopt a rotation shaft to serve as the transmission device 2. A top end of the transmission device is linked with an output end of the power mechanism 1. A bottom part of the transmission device 2 penetrates through a cavity of the pump body 5 and is located below the pump body 5. A section of the transmission device 2, which is located in the cavity of the pump body 5, is denoted as a first section of the transmission device. A section of the transmission device 2, which is located outside the cavity of the pump body 5 and below the pump body 5, is denoted as a second section of the transmission device.

A feeding inlet is arranged at a bottom part of the pump body 5. A discharging port is arranged on a sidewall of the pump body 5. The discharging port is intercommunicated with the discharging pipeline 7. An impeller is arranged in the pump body 5 and fixedly sleeved on the first section of the transmission device.

The cutting blade 6 is fixedly sleeved on the second section of the transmission device.

Working principles of the kitchen slurry transportation device are described as follows.

The power mechanism drives the transmission device to rotate with a high speed. Because the impeller in the pump body and the cutting blade at the bottom part of the pump body are coaxially arranged, the transmission device drives the impeller and the cutting blade to rotate with the high speed. Because the cutting blade is located below the pump body, the high-speed rotating cutting blade firstly processes the waste slurry which will enter the pump body with primary crushing and stirring. The waste slurry after primary crushing enters the pump body. Then, under cutting of the impeller, the waste slurry in the pump body is processed with secondary crushing. Finally, the waste slurry after secondary crushing is discharged through the discharging pipeline.

The impeller and the cutting blade constitute a double crushing system. In order to lengthen an overall service life of the transportation device, the cutting blade and the impeller are made of a highly wear-resistant material. Moreover, in order to further increase a cutting and crushing effect on the waste slurry, according to the preferred embodiment of the present invention, the cutting blade 6 is double-blade-typed and edged, the cutting blade 6 is arranged horizontally, and an edge angle thereof is 60°. The impeller has four vanes, and an edge of each vane is a cutting edge, for achieving a high passing rate and further crushing the waste slurry.

Furthermore, a section of the transmission device 2, which is located above the pump body 5, is denoted as a third section of the transmission device. A stainless steel pipeline is hermetically sleeved outside the third section of the transmission device. A flange and/or an expanding supporter 3 are fixedly arranged outside the stainless steel pipeline. Through the flange or the expanding supporter, the present invention is able to be fixed on other devices, and multiple mounting manners are optional.

Furthermore, in order to avoid the pump body being blocked by the waste slurry, the present invention further comprises an eccentric barrier fixed on the transmission device 2. The eccentric barrier is located between the cutting blade 6 and the impeller, for filtering the slurry from the cutting blade 6 to the impeller.

Furthermore, a mechanical sealing element 4 is arranged at a top part of the pump body 5, for avoiding a slurry leakage.

The kitchen slurry transportation device provided by the present invention is a specialized device for processing thick liquids and various non-homogeneous liquids, and able to be directly applied in transporting the various waste slurries. A main body of the kitchen slurry transportation device is made of high-quality stainless steel, for providing stable performance under a severe working condition. The transportation device is generally dry-mounted, and a power part adopts a conventional electric motor. When the transportation device is required to be used under liquid, a hydraulic motor or a submersible motor is adopted to serve as the power part. The present invention has a high flexibility.

The present invention has following advantages.

(1) The transportation device is able to be mounted in other manners through the expanding supporter. Through the expanding supporter, an accessory device is mounted and the transportation device is fixed on other devices.

(2) The main body of the transportation device is made of the stainless steel, which is able to resist corrosion of the kitchen waste.

(3) The double crushing system is adopted. The cutting blade at the bottom part of the pump body firstly crushes and stirs the kitchen waste, so as to crush long staple materials and break large materials, which avoids the pump body and subsequence devices being wound and damaged. Then, the impeller processes the waste with secondary crushing, for further increasing a crushing degree of the kitchen waste, so as to realize the waste slurry transportation.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A kitchen slurry transportation device, comprising a power mechanism (1), a transmission device (2), a pump body (5), a cutting blade (6), and a discharging pipeline (7), wherein:
a top end of said transmission device (2) is linked with an output end of said power mechanism (1); a bottom end of said transmission device (2) penetrates through a cavity of said pump body (5) and is located below said pump body (5); a section of said transmission device (2), which is located in said cavity of said pump body (5), is denoted as a first section of said transmission device; and, a section of said transmission device (2), which is located outside said cavity of said pump body (5) and below said pump body (5), is denoted as a second section of said transmission device;
a feeding inlet is arranged at a bottom part of said pump body (5); a discharging port is arranged on a sidewall of said pump body (5); said discharging port is intercommunicated with said discharging pipeline (7); an impeller is arranged in said pump body (5); and said impeller is fixedly sleeved on said first section of said transmission device; and
said cutting blade (6) is fixedly sleeved on said second section of said transmission device.

2. The kitchen slurry transportation device, as recited in claim 1, wherein said power mechanism (1) is an electric motor or a hydraulic motor.

3. The kitchen slurry transportation device, as recited in claim 1, wherein said transmission device (2) is a rotation shaft.

4. The kitchen slurry transportation device, as recited in claim 1, wherein a distance between said cutting blade (6) and said impeller is 170 mm.

5. The kitchen slurry transportation device, as recited in claim 1, wherein: said cutting blade (6) is double-blade-typed and edged; said cutting blade (6) is arranged horizontally, and an edge angle thereof is 60°; said impeller has four vanes, and an edge of each vane is a cutting edge.

6. The kitchen slurry transportation device, as recited in claim 1, wherein: the transportation device further comprises an eccentric barrier, which is fixedly sleeved on said transmission device (2) and located between said cutting blade (6) and said impeller.

7. The kitchen slurry transportation device, as recited in claim 1, further comprising a stainless steel pipeline, wherein: a section of said transmission device (2), which is located above said pump body (5), is denoted as a third section of said transmission device; and said stainless steel pipeline is hermetically sleeved outside said third section of said transmission device.

8. The kitchen slurry transportation device, as recited in claim 7, wherein a flange and/or an expanding supporter are fixedly arranged outside said stainless steel pipeline.

9. The kitchen slurry transportation device, as recited in claim 1, wherein a mechanical sealing element (4) is arranged at a top part of said pump body (5), for avoiding a slurry leakage.
